(19) United States
(12) Patent Application Publication
(10) Pub. No.: US 2019/0135620 A1
(43) Pub. Date: May 9, 2019

(54) ON-DEMAND HYDROGEN GENERATOR AND METHOD FOR GENERATING HYDROGEN ON-DEMAND

(71) Applicant: Xiliang Nie, Elk Grove, CA (US)

(72) Inventor: Xiliang Nie, Elk Grove, CA (US)

(21) Appl. No.: 15/808,353

(22) Filed: Nov. 9, 2017

(51) Int. Cl. C01B 3/04; B01J 21/06; B01J 35/00; B01J 19/12; B01J 19/08

(52) U.S. Cl. CPC C01B 3/042; B01J 21/063; B01J 35/004; B01J 2219/0803; B01J 19/088; B01J 2219/1203; B01J 2219/0877; B01J 19/122

(57) ABSTRACT

An on-demand hydrogen generator and method therefor is presented herein. In particular, the present invention utilizes the photocatalytic activity of one or more photocatalysts dispersed throughout an amount of water to generate hydrogen, such as hydrogen gas (H₂), on-demand. Specifically, a reservoir with an amount of water or other fluid is included. A plurality of photocatalysts (such as, but in no way limited to titanium dioxide) is dispersed substantially throughout the water. An initiator, such as a light wave or UV wave generator, is structured to emit energy upon the photocatalysts dispersed throughout the water. Photocatalysis, caused by the initiator, water and photocatalysts, causes the water to split into hydrogen (h2) and oxygen. The hydrogen can then be obtained, on-demand, via one or more electrodes and used in many different application and environments, including, but not limited to various internal combustion engines for vehicles, generators, power stations, batteries, etc.

### FIELD OF THE INVENTION

The present invention is generally directed to an on-demand hydrogen generator and method therefor. In particular, the present invention utilizes the photocatalytic activity of one or more photocatalysts dispersed throughout an amount of water to generate hydrogen, such as hydrogen gas (H₂), on-demand. The hydrogen obtained can be used in many different applications and environments, including, but not limited to various hydrogen internal combustion engines for vehicles, generators, power stations, batteries, or other systems, devices or products that can benefit from the use of hydrogen on-demand.

### BACKGROUND OF THE INVENTION

Hydrogen or hydrogen gas (H₂) as a fuel cell energy is in high demand in the energy field, particularly due to its clean energy impact and reusable energy production and byproducts. However, there are some significant challenges when it comes to the storage and use of hydrogen, particularly for passenger vehicles and other consumer-based products and systems. Specifically, hydrogen gas is extremely flammable, particularly when exposed to even small amounts of ordinary air. For instance, hydrogen gas and normal or ordinary air can ignite due to the oxygen in the air and the simplicity of the chemical reaction.

Accordingly, the storage and use of hydrogen creates unique challenges due in part to it being easily susceptible to ignition, its ease of leaking and its wide range of combustible mixtures. In addition, hydrogen explosions or ignitions can cause catastrophic physical damage and the loss of life. However, due to the clean nature of hydrogen as a fuel in internal combustion engines, generators, power stations, batteries, etc., it would be beneficial if there was a way in which hydrogen could be used without encountering the significant challenges and drawbacks to its storage.

Furthermore, electricity and solar power energy can be used to create hydrogen in some situations, however, these systems fail in the event the electricity is unable to obtained and/or during non-ideal weather conditions such as cloudy times, rain, snow, etc.

Accordingly, there is a need in the art for a system and/or method that can generate hydrogen on-demand, for example, when needed or desired, in a reliable manner, in order to eliminate or reduce the need to store hydrogen, or otherwise eliminate or reduce the need to store large amounts of hydrogen, while still being able to use the gas as a fuel or energy source. In particular, it would be beneficial for a system or method that can generate hydrogen on-demand for use in passenger vehicles and other like consumer-based or other products.

### SUMMARY OF THE INVENTION

Therefore, in accordance with at least one embodiment of the present invention, an on-demand hydrogen generator and a method to generate hydrogen on-demand is presented herein. The generator or method disclosed in accordance with the various embodiments of the present invention can be used in a wide range of applications, including but in no way limited to internal combustion engines, passenger or other vehicles, generators, power stations, batteries, etc.

For instance, the generator includes a reservoir or tank containing an amount of water or other fluid therein. The tank or reservoir can be retained by or otherwise part of a vehicle or other device, system or product that can benefit or use hydrogen as a gas or fuel. Particularly, in some embodiments, the tank or reservoir can be a closed tank or substantially closed tank that has enclosed side(s), bottom and a top. In some embodiments, the tank or reservoir includes one or more electrodes, such as an anode and cathode pair or a positive and negative electrode, extending into the reservoir, for example, through one of the surfaces such as by being suspended through a top surface of the tank, and in contact with the water or other fluid.

A plurality of photocatalysts are disposed within or dispersed substantially throughout the water or fluid. In some cases, the photocatalysts are mixed within the fluid such that they are substantially dispersed throughout all of the fluid contained within the reservoir.

An initiator is provided that is structured to impart an amount of energy (for example, in the form of a light wave) upon the water or fluid in the tank such that the energy or light wave(s) are exposed to the photocatalysts disposed within or dispersed throughout the water. The initiator is specifically constructed to emit a waveform having an amount of energy in the range of, or slightly larger than, the band gap of the corresponding photocatalyst(s). For example, the initiator may emit a light wave or energy source that is substantially equal to the band gap energy of the photocatalysts or greater than the band gap energy of the photocatalysts. In this manner, the invention, as disclosed in accordance with various embodiments herein, may operate with a plurality of different photocatalysts. In such as case, the initiator will be configured to emit or produce energy (e.g., but not limited to light wave energy) that corresponds to the particular photocatalysts, and specifically, light wave energy that matches or is greater than the energy of the band gap of the corresponding photocatalyst. For instance, in some embodiments, all of the photocatalysts dispersed through or within the water or fluid may be identical or substantially the same photocatalyst.

As just an example, the photocatalysts may be titanium dioxide (TiO₂), which exhibits strong oxidizing photoactivity when irradiated by ultraviolet (UV) rays. In particular, since titanium dioxide has a band gap in the range of approximately 3.0 to 3.2 electronvolts (eV), the initiator of at least one embodiment can be configured to emit a light wave having a photon energy in the range of 3.0 eV to 3.2 eV or greater. Other photocatalysts may be used within the full spirit and scope of the present invention. For example, other photocatalysts with a low band gap may be used to increase the efficiency of the system. In some embodiments, the photocatalysts can be defined as a semiconductor that can form an electron-hole pair, for example.

In any event, with the initiator imparting an amount of energy (e.g., in the form of a light wave or other energy form) upon the photocatalysts in the water or other fluid, photocatalysis causes the water to split into hydrogen (H₂) and oxygen (O₂). The hydrogen can then be extracted or obtained via one of the electrodes, such as the cathode, while the oxygen can be extracted or obtained via the other electrode, such as the anode. For instance, the hydrogen ions will be absorbed by the electrode or pole suspended in the water, which immediately forms into the hydrogen gas (H₂). In some cases, oxygen (O₂) can be introduced into the tank or reservoir, for example, via the initiator or other device, such that the system and/or method of the present invention can operate in conditions of low O₂.

In this manner, the initiator can be activated when hydrogen is needed or desired, and deactivated when hydrogen is not needed or not desired. This allows the system or generator of at least one embodiment of the present invention to be used as a hydrogen generator producing hydrogen on demand, thereby minimizing or eliminating the need to store hydrogen in systems or devices such as passenger vehicles, internal combustion engines, generators, etc. In other words, the initiator can be turned on and/or off to control the amount of hydrogen gas obtained or produced, as demanded.

In some embodiments, we can assume that 100% or approximately 100% of the initiator energy is absorbed by the photocatalysts, since the initiator energy matches or substantially matches the bandgap of the photocatalysts. That system can create the theoretical energy gain efficiency as approximately 33% and initial experimental results have shown that the energy gain efficiency is approximately 20%.

These and other objects, features and advantages of the present invention will become more apparent when the drawings as well as the detailed description are taken into consideration.

### BRIEF DESCRIPTION OF THE DRAWINGS

FIG. 1A is a schematic representation in perspective view of the on-demand hydrogen generator as disclosed in accordance with at least one embodiment of the present invention.

FIG. 1B is a schematic representation in a top view of the on-demand hydrogen generator as disclosed in accordance with at least one embodiment of the present invention.

FIG. 2 is a high level flow chart illustrating the method of generating hydrogen on-demand in accordance with at least one embodiment of the present invention.

Like reference numerals refer to like parts throughout the several views of the drawings provided herein.

### DETAILED DESCRIPTION OF THE INVENTION

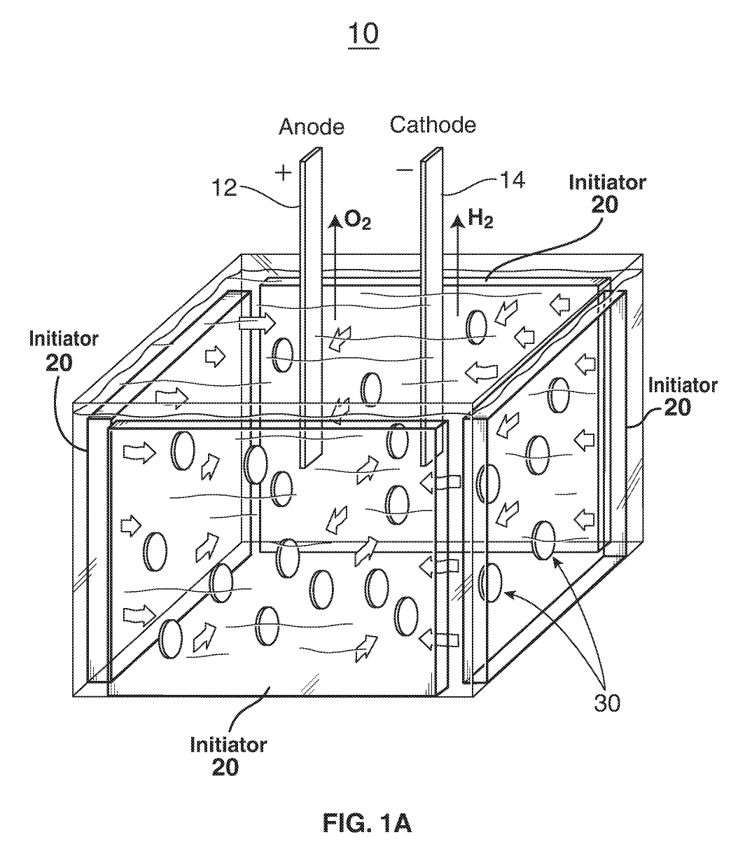

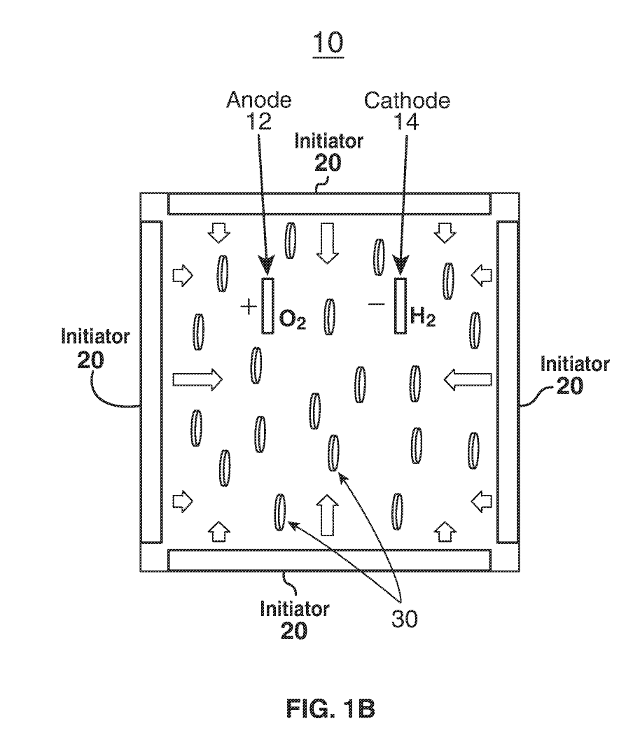

As shown in the accompanying drawings, and with particular reference to FIGS. 1A and 1B, the present invention is directed to an on-demand hydrogen generator, generally referenced as 10. As provided herein, the generator or system 10 is capable of and/or otherwise structured to utilize the photocatalytic activity of one or more photocatalysts 30 to produce or generate hydrogen (H₂) on demand. Once generated, produced, or obtained, the hydrogen can be used in many different applications, devices or system that may benefit from or require hydrogen, including, but in no way limited to hydrogen internal combustion engines, for example.

In particular, the generator or system 10 of at least one embodiment includes a reservoir 16 that includes or otherwise retains or holds an amount of fluid 15 therein. The reservoir 16 may include a closed or substantially closed tank in that it can have one or more sealed sides, a bottom and a top. As described below, one or more electrodes 12, 14 may extend through one of the sides or surfaces, such as through a top surface of the tank and suspend into the water or other fluid.

In some embodiments, the fluid is water (H₂O), although it is possible that other fluids may be implemented depending on, for example, the type of initiator 20 and/or photocatalyst(s) used. The reservoir 16 may be constructed in various shapes and sizes to fit or suit the particular needs or situation. For example, in the embodiment illustrated, the reservoir 16 is constructed in the shape of a cube or cuboid, although other shapes may be implemented such as, but in no way limited to, cylindrical shapes. In some cases, all of the sides, including the top and/or bottom of the reservoir 16 may but need not necessarily be substantially sealed or closed.

In any event, the reservoir 16 can be disposed within a vehicle or other like device for the production of hydrogen on-demand, as will be described or as is apparent from the description provided herein.

Still referring to FIGS. 1A and 1B, and as briefly mentioned above, the reservoir 16 includes one or more electrodes, generally referenced as 12 and 14, disposed therein or otherwise extending at least partially within the water or other fluid 15. Specifically, the electrode(s) 12, 14 may be disposed at least partially within the reservoir 16 and the fluid 15, and extend into and out of the fluid 15, such that the electrodes 12, 14 break the surface of the fluid 15. In some embodiments, the electrode(s) 12, 14 may extend out of the reservoir 16, such as, out of one or more of the sides thereof, in order to provide external access to the electrode(s) 12, 14.

Specifically, in at least one embodiment, the electrodes may include an anode 12 and a cathode 14, or a positive electrode and a negative electrode. The electrodes 12, 14 may be used to extract or otherwise obtain certain products of the present invention. For example, as described herein, in accordance with at least one embodiment, the cathode 14 may be used to extract or otherwise obtain hydrogen (H₂) from the reservoir 16, while the anode 12 may be used to obtain oxygen (O₂) therefrom.

Furthermore, the various embodiments of the present invention will include one or more, and preferably a plurality of, photocatalysts 30 disposed within the fluid 15 or water of the reservoir 16. For instance, as represented via the disc-shaped or circular elements illustrated in the exemplary embodiment of FIGS. 1A and 1B, the photocatalyst(s) 30 may be substantially dispersed throughout the fluid 15 or water such that a substantial amount of the fluid 15 or water contains the dispersed photocatalyst(s) 30. It should be noted that the exemplary drawings in FIGS. 1A and 1B are not meant to be to scale and thus the shape and size of the photocatalysts 30 are provided for simplicity and/or illustrative purposes only. In some embodiments, the photocatalysts may be small crystals or even in a small powder form.

Specifically, a photocatalyst 30, as used herein, is a material that functions as a catalyst when exposed to light or energy, for example. For instance, the photocatalyst(s) 30 may function as a catalyst to provide additional energy other than the initiator's energy to dissolve water to hydrogen gas when exposed to light or energy. Particularly, in some cases, when energy, waves, or light waves are exposed to the photocatalyst(s) 30 of the present invention (or in other words, when the photocatalyst(s) 30 are exposed to the energy, waves, or light waves), the rate of chemical reaction of the photocatalyst(s) 30 may change and/or 100% of the energy or substantially 100% of the energy from the initiator may be absorbed by the photocatalysts. Accordingly, in some embodiments, the photocatalyst(s) 30 may include a semiconductor or like material that can form an electron-hole pair (this is the additional energy other than the initiator's energy to dissolve the water into hydrogen gas). Some embodiments may use a photocatalyzer with a low band gap which may increase the efficiency of the invention. In any event, there are a number of different materials that show photocatalytic capabilities and which can be used as photocatalysts(s) 30 in accordance with the present invention, including, but in no way limited to titanium dioxide (TiO₂).

For instance, titanium dioxide (TiO₂) exhibits photocatalytic activity when exposed to light waves, such as ultraviolet light. In some cases, the photocatalyst(s) 30 may be doped, for example, with nitrogen ions or metal oxide such as tungsten trioxide, in order to enhance the excitation under light or other waveforms. Additional or more information relative to the doping of titanium dioxide (TiO2) to enhance or alter its photocatalytic properties can be found in the following article: “Doping of TiO2 Polymorphs for Altered Optical and Photocatalytic Properties,” written by Xiliang Nie et al., Hindawi Publishing Corporation, International Journal of Photoenergy, Volume 2009, Article ID 294042, the contents of which are incorporated herein in its entirety.

In this manner, and still referring to FIGS. 1A and 1B, at least one embodiment further includes an initiator, generally referenced as 20. The initiator 20 is structured to emit or otherwise impart an amount of energy, such as light or UV energy in the form of light waves or other energy waves, upon the photocatalyst(s) 30 disposed within or dispersed substantially throughout the water or other fluid 15. In some embodiments, the initiator 20 may be disposed within the reservoir 16 in order to more effectively shine or emit the energy upon the photocatalysts 30. For example, the initiator 20 may be disposed on one or more sides or interior surfaces of the reservoir 16 and directed to emit or impart the energy or light waves toward the center or inside of the reservoir 16. This will ensure that most or all of the water or fluid disposed within the reservoir 16 is exposed to the light or other energy, thereby maximizing the amount of light or other energy imparted upon the photocatalyst(s) 30 disposed or dispersed therein. In this manner, each of the initiators may be independently controlled (e.g., turned on and/or off) in order to control the output or production of hydrogen gas.

In some embodiments (not shown), the initiator 20 may be external to the reservoir 16, in which case, the energy or light waves may penetrate through the reservoir 16, such as through one or more sides or surfaces thereof. In such a case, the reservoir 16 may be constructed of a transparent material allowing the penetration of the energy or light waves there through.

In any event, the initiator 20 of at least one embodiment is configured to generate or produce energy, for example, in the form of a wave or light wave, and impart that energy upon the photocatalyst(s) 30 within the water or other fluid. In some embodiments, the initiator 30 is thus a light wave or UV generator that shines or emits light upon the inside of the reservoir 16 such that the photocatalyst(s) 30 are exposed to the light waves. Other embodiments may implement or use other initiators that are structured to generate waveforms or energy in the manner described in accordance with at least one embodiment, including, for example, laser generators, etc.

The energy or light generated by the initiator 30 may depend on the type of photocatalysts 30 used or dispersed throughout the water or fluid 15. For example, the goal of certain embodiments is to create and/or facilitate a reaction or to facilitate excited electrons caused by photocatalysis. In particular, in solid-state physics, solids include a valence band and a conduction band that determine, at least in part, the electrical conductivity of the solid. Briefly, the valence band is the band of energy that is occupied by the valence electrons, while the conduction band is often the lowest unfilled energy band where conduction electrons can generally move freely. In semiconductors and insulators, the valence band and the conduction band are separated by a band gap. The band gap is an energy range or void region between the valence band and the conduction band where no electron states exist due to the quantization of energy. When a photon with energy that is equal to or greater than the band gap of the particular material is absorbed or exposed to the material, an electron is excited from the valence band to the conduction band. This electron-hole pair is the source of energy or additional energy that assists in the dissolving of water into hydrogen gas.

In some embodiments of the present invention, the initiator 20 is structured to generate or otherwise emit or impart an amount of energy equal to or greater than the band gap associated with the photocatalyst(s) 30. The energy or light waves provided by the initiator 20 of at least one embodiment will thus be sufficient to excite an electron from the valence band to the conduction band of the photocatalyst(s) 30. The initiator's energy is part of the total amount of energy used to dissolve water into hydrogen gas. For instance, in at least one embodiment of the present invention, the total amount of energy used to dissolve water into hydrogen gas is the initiator's energy plus the energy from the electron-hole pair. The energy from the electron-hole pair may partially contribute to the chemical energy or other energy from inside the photocatalyst(s).

In any event, it should be noted that titanium dioxide (TiO₂) has a band gap of approximately 3.0 to 3.2 eV. Thus, in the exemplary embodiments wherein the photocatalysts 30 used or otherwise dispersed throughout the water or fluid 15 is titanium dioxide (TiO2), the initiator 20 is constructed to emit energy or light waves in the range of approximately 3.0 to 3.2 eV, or in some cases, greater than the band gap range Referring to the chart provided below, the photon energy provided by the initiator 20 may thus be in the violet light spectrum and have a wavelength in the range of 380 to 450 nanometers.

| COLOR | WAVELENGTH | FREQUENCY | PHOTON ENERGY |
|---|---|---|---|
| Violet | 380-450 nm | 668-789 THz | 2.75-3.26 eV |
| Blue | 450-495 nm | 606-668 THz | 2.50-2.75 eV |
| Green | 495-570 nm | 526-606 THz | 2.17-2.50 eV |
| Yellow | 570-590 nm | 508-526 THz | 2.10-2.17 eV |
| Orange | 590-620 nm | 484-508 THz | 2.00-2.10 eV |
| red | 620-750 nm | 400-484 THz | 1.65-2.00 eV |

Accordingly, in this exemplary embodiment, the initiator 20 may include a light source or a device structured to emit light in the violet spectrum or otherwise light having a wavelength in range of 380 to 450 nanometer and photon energy in the 2.75 to 3.26 eV range, or specifically, relative to titanium dioxide, in the range of 3.0 to 3.2 eV.

It should be noted and apparent that other photocatalysts 30 may be used in accordance with scope and spirit of the present invention. Since other photocatalysts 30 may have a different band gap than that of titanium dioxide, the initiator 20 may generate energy in a different range, and specifically, in the range of the band gap or greater than the bad gap of the selected photocatalyst. Thus, the initiator 20 of at least one embodiments is structured to emit or impart an energy or wave that corresponds to the selected photocatalysts, and in particular, an energy or wave that will create photocatalysis upon the photocatalysts, such as an energy or wave within or greater than the band gap associated with the photocatalysts.

In other embodiments, the initiator 20 may include a low energy natural spontaneous radiation compound that can emit energy lower that 10 eV. In such as case, the energy gain efficiency may be 100% or approximately 100%.

Accordingly, when photocatalysis occurs, or otherwise, then the initiator 20 imparts or emits the corresponding energy upon the photocatalysts 30 in the reservoir 16, an amount of hydrogen (H₂) can be obtained, for example, via one or more of the electrodes, such as the cathode 14, extending therefrom. This hydrogen can be used via an external or other system, such as an internal combustion engine, power station, generator, battery, etc., as desired or as part of the system. It should also be noted that, in some embodiments, oxygen (O₂) can be obtained via another one of the electrodes, such as the anode 12. In other words, the present invention can be used to separate the water (H₂O) into hydrogen (H₂) and oxygen (O₂), in order to utilize the hydrogen (H₂) and/or oxygen (O₂) in other various systems or devices.

Furthermore, the initiator 20 can be configured in a manner such that most, and in some embodiments, all of (approximately 100%) the energy produced or emitted by the initiator 20 can be absorbed by the photocatalyst(s) 30. This is due to the energy produced by the initiator 20 being within or, in some embodiments, only slightly above, the band gap of the photocatalyst(s) 30. For instance, the O—H chemical bond energy can be represented as being equal to the initiator electron excited from the valence band to the conduction band (e.g., the photoncatalyst)+the additional electron-hole pair energy to dissolve water to hydrogen (H₂) of the photoncatalyst. Specifically, the O—H bond energy is approximately 4.8 eV, and the TiO₂ band gap is approximately 3.2 eV (which is the energy the initiator will generate to impart upon the system or upon the photocatalysts). Accordingly, the efficiency of the system can be derived as follows:

Efficiency=(output energy−input energy)/(output energy)

Thus, in this example, using TiO₂:

Efficiency=(4.8 ev−3.2 eV)/(4.8 ev)=0.33=33%

This allows the system to obtain additional energy, for example, and additional 20% to 33%, that can be used in other external systems, as desired. It should be noted that the efficiency can be adjusted or modified or increased, for example, up to or approaching 100%, by using low energy radiation compounds (i.e., the energy around the band gap of the photocatalyst) to excite the electron from the valence band to the conduction band. In some cases, however, the band gap of the semiconductor or photocatalysts may need to be greater than 1.23 eV in order for it to dissolve or split the water into H₂ and O₂.

Moreover, since, in many applications, the byproduct of the reaction will be water, there is very little, if any, loss of water in the current system or device. Accordingly, the generator 10 of at least one embodiment of the present invention may reuse the water again and again, and thus, refilling the reservoir with water may only need to occur extremely rarely, if ever. The photocatalyst(s) 30, however, may need to be periodically replenished, depending on, for example, the amount of use and the particular photocatalysts used as different photocatalysts may have different lifespans.

Furthermore, it should also be noted that the initiator 20 can be turned on and/or off in order to selectively activate and deactivate the system, respectively. This allows the system and/or generator to be used in a manner for the on-demand production of hydrogen in that, by turning the initiator(s) 20 off (e.g., removing the light source or energy from the reservoir), the system or generator will cease the production of hydrogen. Similarly, by turning the initiator(s) 20 on (e.g., by activating the initiator to being imparting energy upon the photocatalysts), the production of hydrogen will begin or continue. Advantageously, this eliminates the need to maintain a constant or large supply of hydrogen at a particular time. In some embodiments, multiple initiators 20 may be independently controlled or independently turned on and/or off to further control the production of hydrogen gas via the system or method disclosed herein. Specifically, since hydrogen is a gas that can be easily ignited causing large explosions and destruction, the ability to produced hydrogen on-demand by selectively activating and/or deactivating the initiator 20 provides a significant benefit in the field.

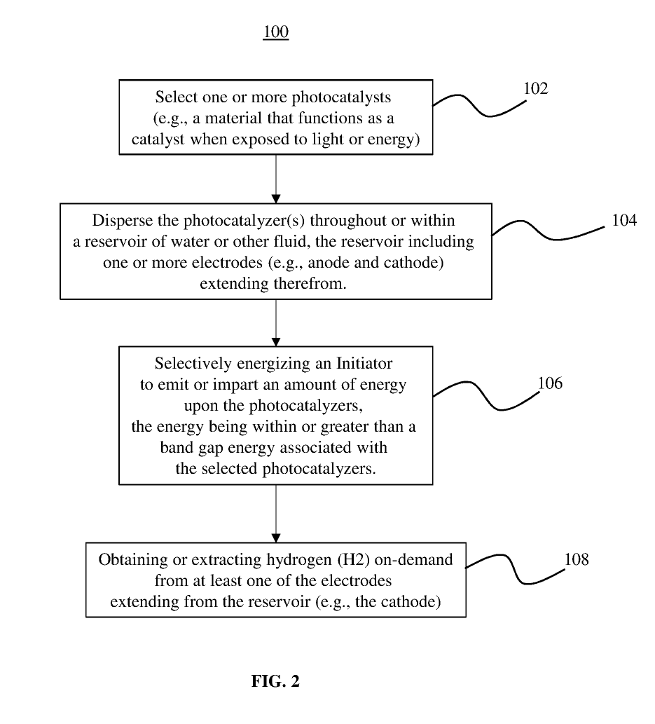

Referring now to FIG. 2, at least one embodiment of the present invention also includes a method for generating hydrogen on demand, as generally referenced as 100. In particular, as shown at 102, the method 100 includes selecting or defining a photocatalyst that can be used in accordance with the present invention. For example, a photocatalyst 30, as used herein, is a material that functions as a catalyst when exposed to light or energy or otherwise exhibits photocatalytic activity when exposed to light or energy. Particularly, in some cases, when energy, waves, or light waves are exposed to the photocatalyst(s) 30 of the present invention, the rate of chemical reaction of the photocatalyst(s) 30 may change. There are a number of different materials that show photocatalytic capabilities, including, but in no way limited to titanium dioxide (TiO₂) or titanium dioxide.

The photocatalyst(s) 30 are then disposed or dispersed throughout a reservoir that contains an amount of water of other fluid, as represented as 104 in FIG. 2. In some embodiments, the photocatalysts 30 are dispersed substantially throughout the water, for instance, by floating or otherwise being substantially mixed throughout the water or fluid. In this manner, when energy or light is imparted upon the water, a substantial amount or all of the water contains the photocatalysts therein in order to maximize the exposer.

In this regard, with the photocatalysts dispersed throughout the water, one or more initiators is/are activated 106 in order to impart energy sufficient to create photocatalysis and/or sufficient to excite an electron in the valence band of the photocatalyst to the conduction band of the photocatalyst. In order to do so, the initiator may impart or emit energy within the band gap of the corresponding photocatalyst. As just an example, the band gap of titanium dioxide (TiO₂) is approximately in the range of 3.0 to 3.2 eV. However, since other photocatalysts can be used in accordance with the various embodiments of the present invention, the initiator can also emit energy in different ranges sufficient to be within or greater than the band gap of the corresponding photocatalyst.

While the initiator is imparting energy upon the photocatalysts, for example, while the initiator is shining light within the reservoir, photocatalysis separates the water into hydrogen (H₂) and oxygen (O₂) which may be obtained or extracted 108 via corresponding electrodes disposed within the reservoir or water. For instance, hydrogen may be obtained via the cathode while oxygen may be obtained via the anode. In this manner, photocatalysis can be controlled by activating and/or deactivating the initiator(s), such that, when hydrogen is wanted, needed or desired, the initiator can be activated and hydrogen can be obtained via the corresponding electrode. The hydrogen is thus considered generated on-demand.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention. This written description provides an illustrative explanation and/or account of the present invention. It may be possible to deliver equivalent benefits using variations of the specific embodiments, without departing from the inventive concept. This description and these drawings, therefore, are to be regarded as illustrative and not restrictive.

Now that the invention has been described,

What is claimed is:

1. An on-demand hydrogen generator, comprising:
a reservoir containing an amount of fluid disposed therein,
at least two electrodes disposed at least partially within said reservoir and said fluid, and extending at least partially out of said fluid,
at least one photocatalyst disposed within said fluid in said reservoir,
an initiator configured to impart an amount of energy upon said at least one photocatalyst,
wherein said energy is within a band gap of said at least one photocatalyst, and
wherein, upon imparting said energy upon said at least one photocatalyst via said initiator, an amount of hydrogen (H₂) is obtained on demand via at least one of said at least two electrodes.

2. The on-demand hydrogen generator as recited in claim 1 wherein said fluid disposed within said reservoir comprises water.

3. The on-demand hydrogen generator as recited in claim 2 wherein said initiator comprises a light wave generator configured to generate light waves corresponding to the band gap associated with said at least one photocatalyst.

4. The on-demand hydrogen generator as recited in claim 2 wherein said initiator comprises a low energy chemical compound configured to emit low amounts of energy corresponding to the band gap associated with said at least one photocatalyst.

5. The on-demand hydrogen generator as recited in claim 1 further comprising a plurality of photocatalysts dispersed substantially throughout said fluid disposed within said reservoir.

6. The on-demand hydrogen generator as recited in claim 5 wherein at least some of said plurality of photocatalysts comprise titanium dioxide (TiO₂).

7. The on-demand hydrogen generator as recited in claim 6 wherein said initiator is configured to emit energy between 3.0 eV and 3.2 eV.

8. The on-demand hydrogen generator as recited in claim 1 wherein said initiator is disposed within said reservoir.

9. The on-demand hydrogen generator as recited in claim 8 wherein said at least two electrodes are defined as comprising an anode and a cathode.

10. The on-demand hydrogen generator as recited in claim 9 wherein said an amount of hydrogen (H₂) is obtained on demand via said cathode.

11. An on-demand hydrogen generator, comprising:
a reservoir containing an amount of water disposed therein,
at least two electrodes disposed at least partially within said reservoir and the water, said at least two electrodes also extending at least partially out of the water,
a plurality of photocatalysts dispersed substantially throughout the water within said reservoir, and
an initiator disposed within said reservoir, said initiator configured to impart energy upon said plurality of photocatalysts, wherein said energy is sufficient to excite an electron from the valence band of said plurality of photocatalysts to the conduction band of said plurality of photocatalysis, and
wherein, upon imparting said energy upon said plurality of photocatalysts via said initiator, photocatalysis generates an amount of hydrogen (H₂) which is obtained on demand via at least one of said at least two electrodes.

12. The on-demand hydrogen generator as recited in claim 11 wherein said plurality of photocatalysts comprise titanium dioxide (TiO₂).

13. The on-demand hydrogen generator as recited in claim 12 wherein said initiator comprises a light wave generator configured to generate light waves comprising wavelengths between 3.0 eV and 3.2 eV.

14. A method for generating hydrogen (H₂) on demand, the method comprising:
selectively energizing an initiator to impart energy upon a plurality of photocatalysts substantially dispersed throughout an amount of water disposed within a reservoir, the energy imparted by the initiator being sufficient to excite an electron from the valence band of said plurality of photocatalysts to the conduction band of said plurality of photocatalysts, wherein at least two electrodes are disposed within, and extending at least partially out of, the water within the reservoir, and
obtaining an amount of hydrogen (H2) from at least one of the at least two electrodes generated via photocatalysis within the water.

15. The method as recited in claim 14 wherein the initiator is disposed within the reservoir and configured to impart energy upon the amount of water and the plurality of photocatalysts disposed therein.

16. The method as recited in claim 15 wherein the initiator comprises a light wave generator configured to generate light waves corresponding to a band gap associated with said plurality of photocatalysts.

17. The method as recited in claim 16 wherein said plurality of photocatalysts comprise titanium dioxide (TiO₂).

18. The method as recited in claim 17 wherein the initiator comprises a light wave generator configured to generate light waves comprising wavelengths between 3.0 eV and 3.2 eV.
